(19) United States
(12) Patent Application Publication
(10) Pub. No.: US 2002/0071346 A1
(43) Pub. Date: Jun. 13, 2002

(54) Portable object, in particular a timepiece, including a sealed container mounted in a metallic case

(76) Inventors: Daniel Paratte, Neuchatel (CH); Andre Zanetta, Neuchatel (CH); Fabien Blondeau, Le Landeron (CH)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/994,885

(22) Filed: Nov. 28, 2001

(30) Foreign Application Priority Data
Dec. 11, 2000 (CH) 2405/00

(51) Int. Cl. G04B 47/00

(52) U.S. Cl. 368/10

(57) ABSTRACT

The present invention concerns a portable object such as, in particular, a timepiece, intended to co-operate with a contactless remote interrogation system, this portable object (1) including a metallic case (2) and a transponder (76) including a transmission and/or reception circuit (78) for a radio-broadcast signal and an antenna (80) connected to the transmission and/or reception circuit (78), a sealed container (24) made of an electrically insulating material inside which the horological components are housed being mounted and held in place in the metallic case (2), characterised in that said metallic case (2) has a slot (94).

The present invention concerns a portable object, in particular a timepiece, including a case with which is associated an electronic module intended to allow contactless and wireless communication between the portable object and an external terminal provided for such purpose.

The present invention is intended for a multitude of situations or places where, for example, a check is carried out as to whether a person has right of access free of charge or not.

The invention is intended particularly for systems for controlling access to industrial sites (research and development laboratories, production units, etc.) and to public buildings (stadiums, museums, cinemas or suchlike) in which the portable object is presented by its owner to a checking device which only authorises access to the site or building if the information stored in the object carried by the person corresponds to an access authorisation, payment of a sum or a suitable expiry date.

Access control systems are known which implement cards provided with a magnetic path and able to be inserted into the slot of an access control terminal inside which the data carried by the magnetic path is read. When this data is recognised as being valid by the control system, access authorisation is granted and new data can be written on the magnetic path.

Magnetic card access control systems are sometimes inconvenient to use, in particular because of the narrowness of the slot into which the card has to be inserted in order for its contents to be read. Thus, when the magnetic card access control system is used in certain installations such as, for example, ski lifts in ski resorts, it is particularly slow and awkward for users wearing gloves and carrying poles to handle the magnetic card. Moreover, the repeated insertion of the card into the slot of the terminal wears out the magnetic path on which the useful data is stored.

In order to overcome these drawbacks, there has been proposed an automatic object control and identification system wherein a portable object encloses, in a case, an electronic module or transponder including in particular a memory for storing useful data such as an identification code, a radio-broadcast signal transceiver device, and an antenna electrically connected to the transceiver device.

In such an object control system, the transceiver device is capable, when it is coupled to an external read and/or write terminal provided for such purpose, to transmit radio-broadcast signals corresponding to the reading of the data stored in the memory circuit, and, if necessary, to receive radio-broadcast signals to re-write new useful data in the memory circuit. Thus, when the external terminal transmits an interrogation signal, detection of this signal by the portable object causes the transmission, for example of an identification code for such object, which then allows the terminal to identify the object and consequently to check the identity of the person carrying it.

The above automatic object identification system provides numerous advantages.

Access controls, whether paying or not, are made easier and quicker. Indeed, the identification or other necessary information is written or read in the memory in a contactless and wireless manner. Thus, for example, the operation of mechanically inserting a card in the slot of a reader, often made difficult by circumstances, is omitted.

Moreover, this system is entirely passive, i.e. it does not require its own power source. The transponders in fact include an integrated circuit and a coil acting as an antenna which together form a passive transceiver unit. The read and/or write apparatus supply the transponder with energy from the exterior by generating an electromagnetic field which is picked up by the coil forming the antenna. In turn, the transponder transmits the data by electromagnetic waves. The data stored in the memory of the integrated circuit may thus be read and/or modified, i.e. reprogrammed, from a distance.

The passive transponder systems of the type described above thus combine the advantages of security, time saving and comfort in their daily use and are thus highly useful both for the persons carrying them and for the persons managing such systems.

However, these passive transponder systems must be able to operate faultlessly in environments which are sometimes hostile because of heat, cold, damp or the presence of dust.

In order to deal with these constraints, one solution, which with use has proved very advantageous, consisted in housing these transponders in cases such as watch cases. Thus sheltered from external attacks, the transponders do not require any maintenance and the data they contain can be read and modified for years.

A solution of this type is known, for example, from European Patent No. 0 844 685 in the name of the Applicant. This Patent concerns a timepiece of the wristwatch type including a receiving and/or transmitting antenna for a radio-broadcast signal. As explained hereinbefore, this type of wristwatch is intended to communicate at a distance with an external device, for example with an object identification system. In such a system, each watch includes a memory circuit enclosing a unique identification code for the watch, a radio-broadcast signal reception and transmission circuit and an antenna connected to said circuit. The aforementioned external device is able to transmit an interrogation signal. Detection of this signal generates the transmission of an identification signal by the wristwatch in question, this signal being representative of the identification code stored in its memory. Thus, by identifying the wristwatch by its identification code, the external device can control the identity of the person wearing the wristwatch.

In accordance with the embodiment disclosed in European Patent No. 0 844 685, the wristwatch includes a transponder including an antenna and a radio-broadcast signal transceiver circuit integrated in the bezel of the watch. Thus, the horological part (middle part, crystal, movement, dial, hands, etc.) and the receiver part (antenna, transceiver circuit) of the wristwatch can be manufactured and tested independently of each other prior to mounting the bezel on the case during the final assembly of said wristwatch. The transponder further includes means for powering the transceiver circuit which may take the form of a battery or, preferably, a rectifier circuit for the signals picked up by the antenna arranged in the bezel. It is thus possible to integrate the transponder entirely in the bezel of the watch.

The wristwatch described above has, however, a drawback. Indeed, the case and the bezel of this watch have to be made of a plastic material for example via injection moulding techniques. The choice of a plastic material for making the case and the bezel is dictated by electromagnetic related considerations. Indeed, if said case and said bezel were made of a metallic material such as, for example, a stainless steel, an electric current induced by the electromagnetic field generated by the remote external interrogation device would appear in the case and bezel when said external device transmits an identification signal towards the watch. The current induced in the bezel and in the case would in turn generate a interfering magnetic field which would seriously disrupt communication between the remote external interrogation device and the watch, making such communication practically impossible. Consequently, the choice of manufacturers of this type of watch has been limited to date to electrically non-conductive materials such as plastic or ceramic materials. It will easily be understood that such a limitation in the choice of materials constitutes a significant drawback for watch manufacturers who would like to be able to put on the market watches made of all types of material, and in particular steel, in order to follow changes in fashion.

There is also known from European Patent No. 0 170 900 in the name of the Applicant, a timepiece of the wristwatch type including a sealed container made of a plastic material inside which the horological components are housed. This sealed container is closed by a crystal and by a battery compartment cap. It is further fitted with a time-setting stem mounted in a sealed manner on said container. The container is mounted and held in place in a metallic case by locking means of the snap-fitting type such as, in particular, a bezel. The sealed container and its watch movement can thus be tested prior to being mounted in the metallic case.

The object of the present invention is to overcome the aforementioned drawbacks in addition to others by proposing a portable object, such as, in particular, a timepiece, intended to communicate with a remote external interrogation device and able to be made of any type of material and, in particular, of a metallic material.

The present invention thus concerns a portable object such as, in particular, a timepiece, intended to co-operate with a contactless remote interrogation system, this portable object including a metallic case and a transponder including a transmission and/or reception circuit for radio-broadcast signals and an antenna connected to the transmission and/or reception circuit, a sealed container made of an electrically insulating material inside which the horological components are housed being mounted and held in place in the metallic case, characterised in that said metallic case has a slot.

As a result of these features, the case of the portable object can be made of an electrically conductive metallic material without altering the sensitivity of the remote contactless interrogation system between said portable object and a remote external communication device. Indeed, since the metallic case has a slot, it no longer constitutes an interfering antenna for the communication system insofar as it has infinite electrical resistance and is hence no longer a conductor of electricity.

Consequently, the variable electromagnetic field generated by the remote external interrogation device will no longer be able to induce any electric current in the metallic case which, in turn, will no longer produce any back-electromotive force able to disrupt communication between said interrogation device and the portable object.

According to a complementary feature of the invention, the metallic case also has a recess at its centre.

Indeed, depending upon the magnetic permeability of the metallic material used to make the case and depending upon the surface area of said case through which the magnetic field passes, said case will pick up a more or less significant quantity of electromagnetic flux generated by the remote interrogation device, so that the useful flux picked up by the transponder antenna is capable of varying. In order to guarantee a good system yield and high quality communication between the interrogation device and the portable object independently of the physical properties of the metallic materials used, the case is hollowed-out so as to reduce the interfering magnetic flux which passes through said case and to increase the useful flux which will pass through the transponder antenna.

According to another feature of the invention, two holes are machined on either side of the slot in the metallic case or in the container and each accommodate mechanical holding means carried by the container, or respectively the case.

The case, which is slit and hollowed-out at its centre, has lower mechanical resistance. If, for example, the case is provided with a wristband, the traction stress which is exerted on the strands of the wristband may cause a deformation in said case which is capable of bending and opening. In order to overcome this drawback, two blind holes are drilled on either side of the slot, said holes each accommodating a pin driven into the container. Consequently, the container is mounted and held in place in the case, and any traction effort exerted on said case is taken by the container which forms a mono-block unit which cannot be deformed.

Other features and advantages of the present invention will appear more clearly upon reading the following detailed description of an example embodiment of a portable object according to the invention, this example being given purely by way of non-limiting illustration, in conjunction with the annexed drawings, in which:

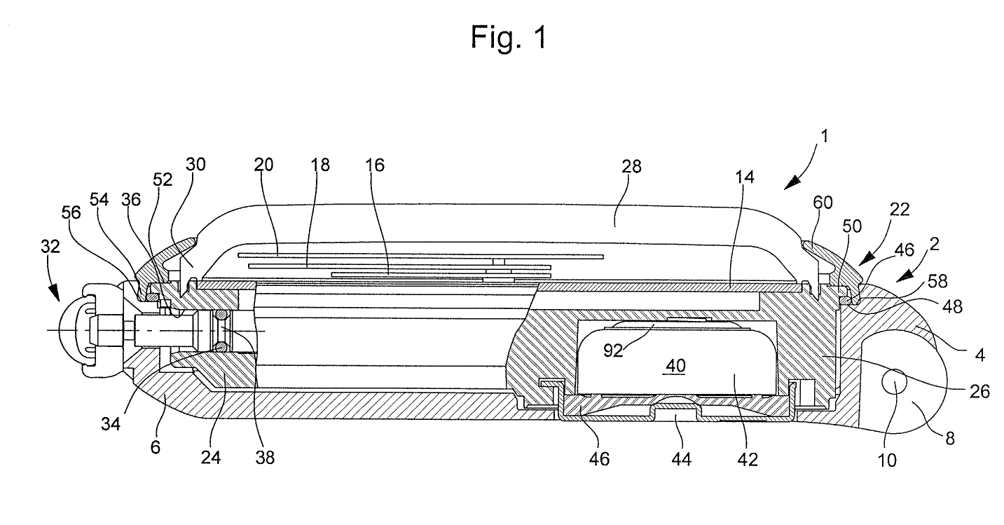

FIG. 1 is a cross-section of a conventional wristwatch formed of a sealed container placed in a metallic case and held by a bezel;

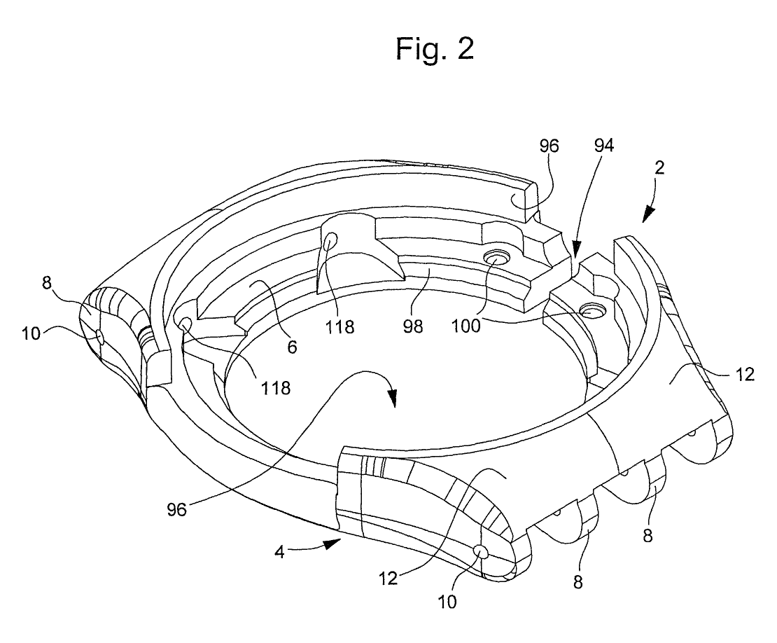

FIG. 2 is a perspective top view of the slit metallic case;

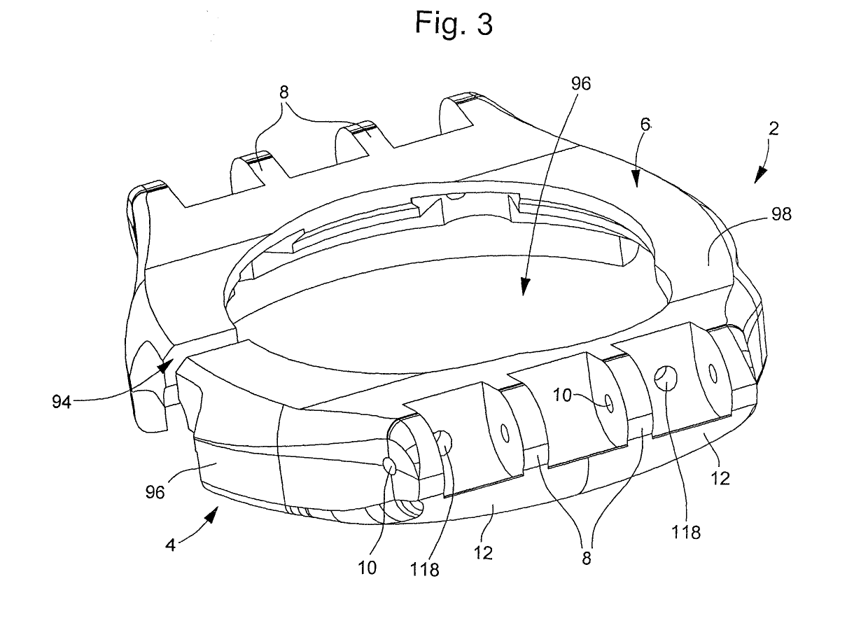

FIG. 3 is a perspective bottom view of the slit metallic case of FIG. 2;

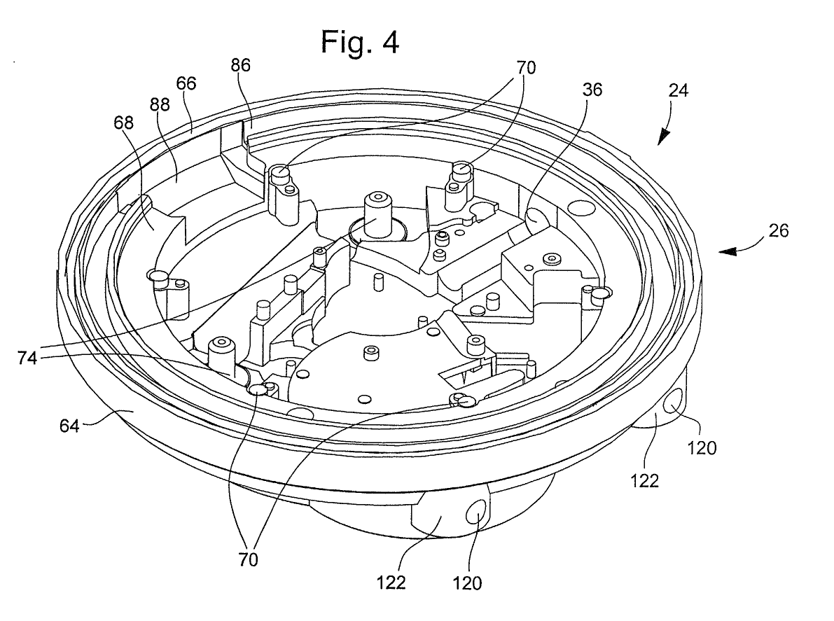

FIG. 4 is a perspective view from the side of the crystal of the container made of plastic material;

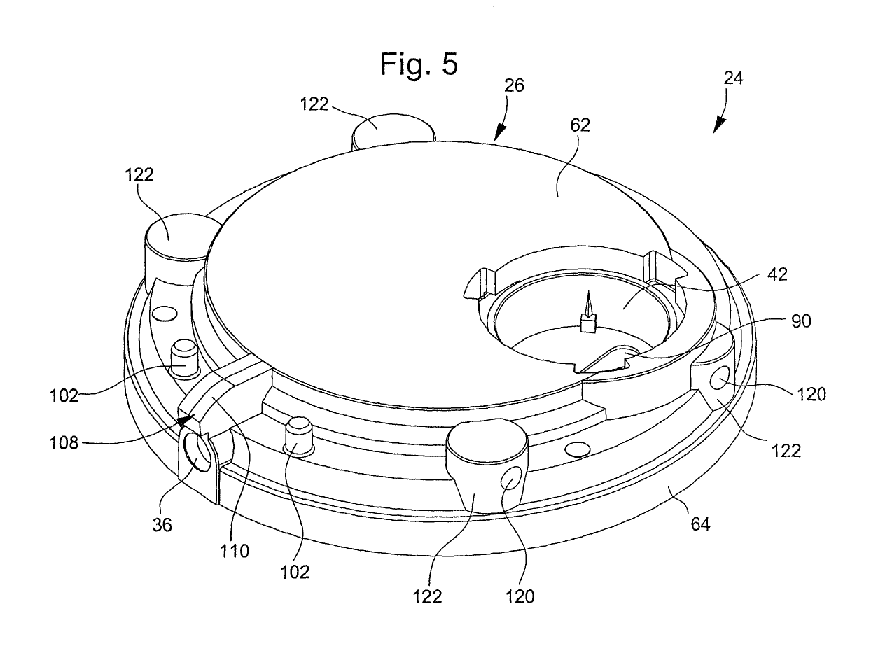

FIG. 5 is a perspective bottom view of the container made of plastic material of FIG. 4;

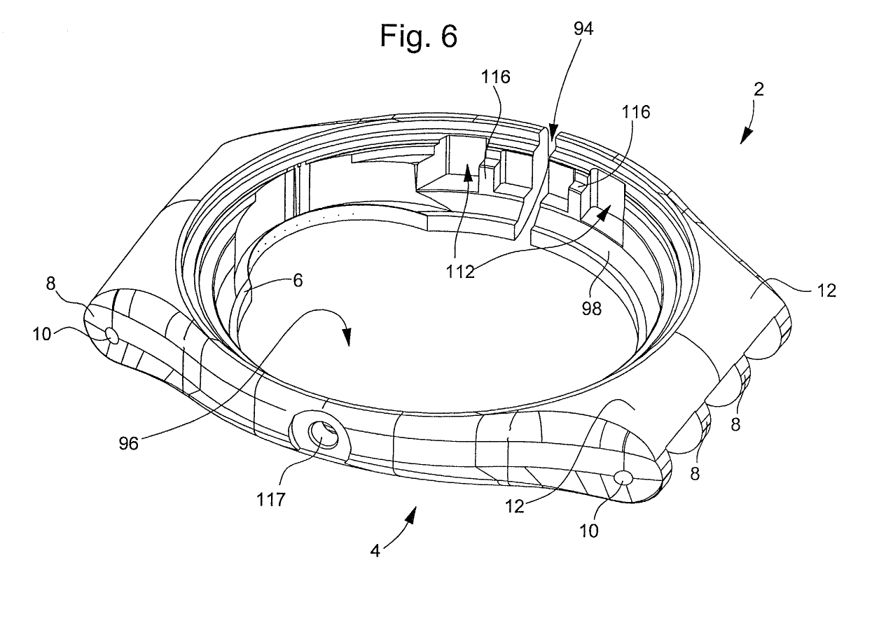

FIG. 6 is a perspective top view of an alternative embodiment of the slit metallic case;

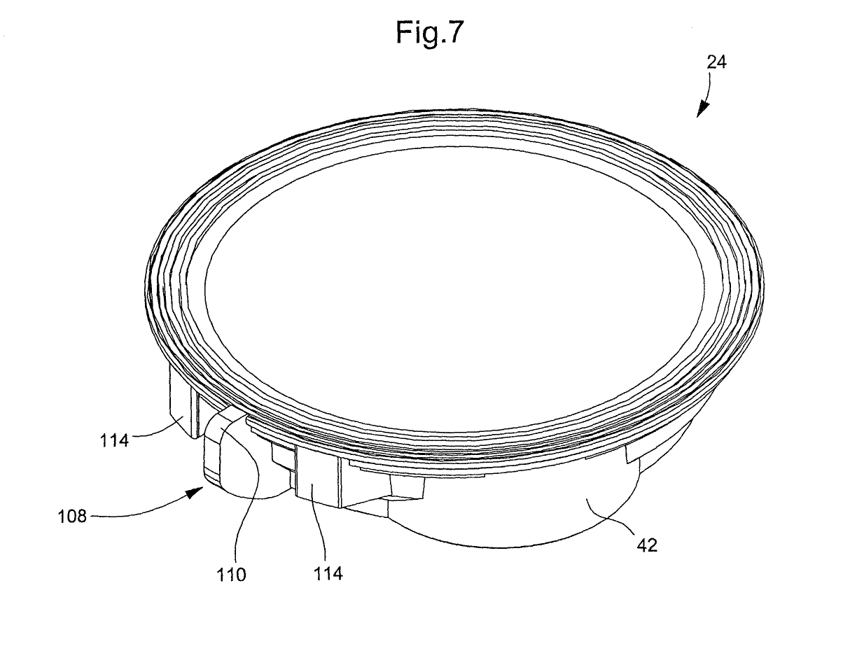

FIG. 7 is a perspective view from the side of the crystal of the container made of plastic material adapted to be mounted and held in place in the slit metallic case of FIG. 6;

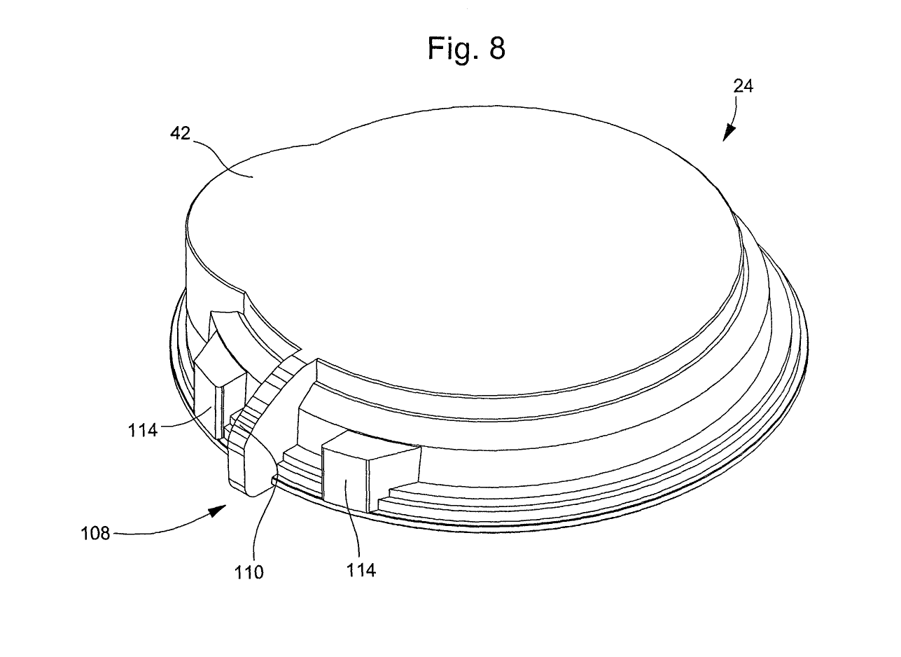

FIG. 8 is a perspective view from the side of the bottom of the container made of plastic material shown in FIG. 7;

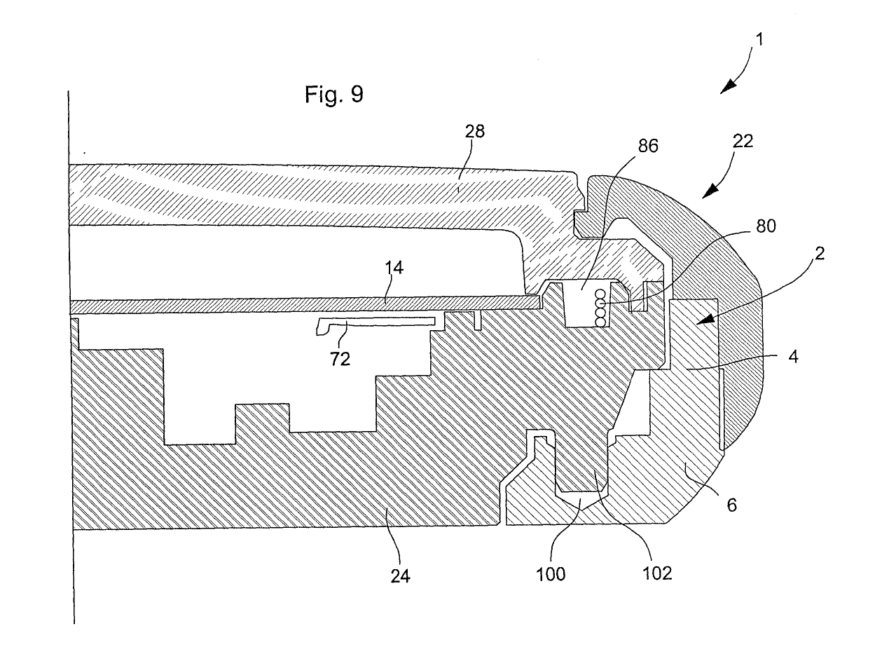

FIG. 9 is a cross-section of a wristwatch according to the present invention in which there appears a stud made in a single piece with the container made of plastic material and which is housed in a corresponding blind hole provided in the metallic case;

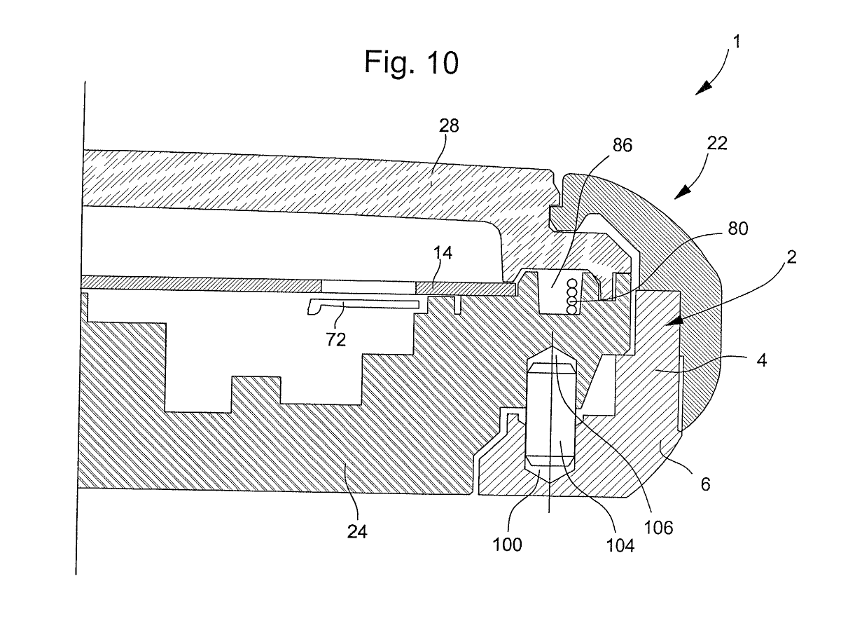

FIG. 10 is a cross-section of a wristwatch according to the present invention in which there appears a pin driven into the container made of plastic material and which is housed in a corresponding blind hole provided in the metallic case;

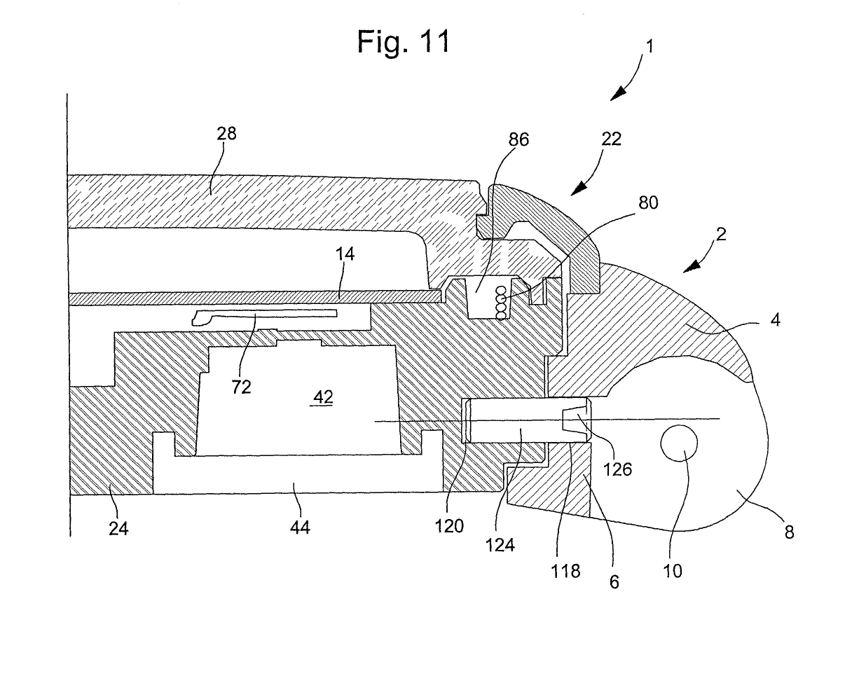

FIG. 11 is a cross-section of a wristwatch according to the present invention which shows that the container is held axially on the metallic case by means of pins engaged radially in a blind hole made in the lateral wall of said metallic case and which is extended into the container;

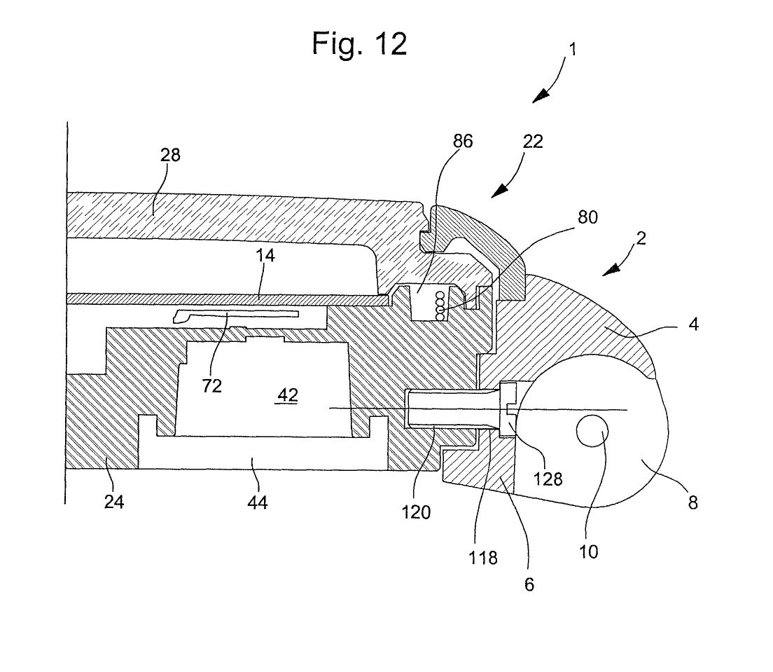

FIG. 12 is a cross-section of a wristwatch according to the present invention which shows that the container is held axially on the metallic case by means of screws screwed radially into said case and passing therethrough so as to be engaged in said container;

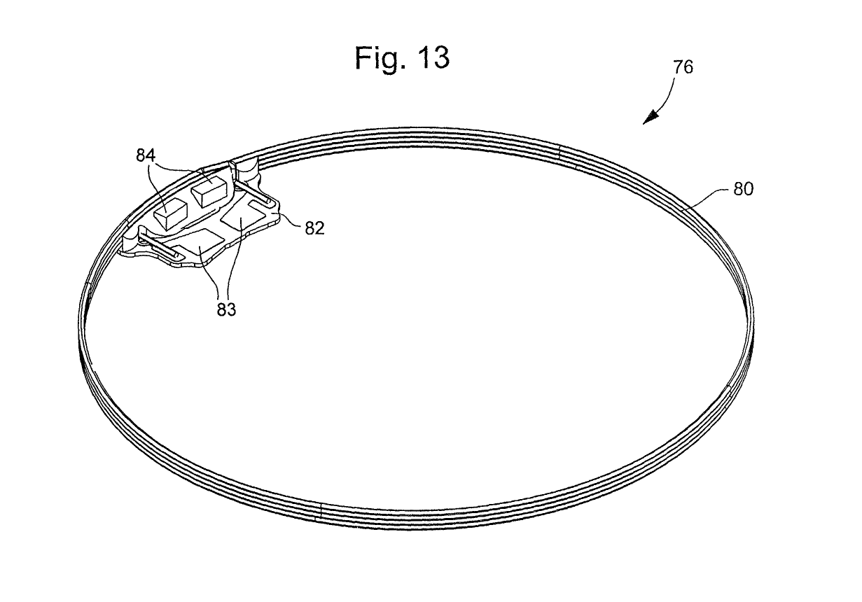

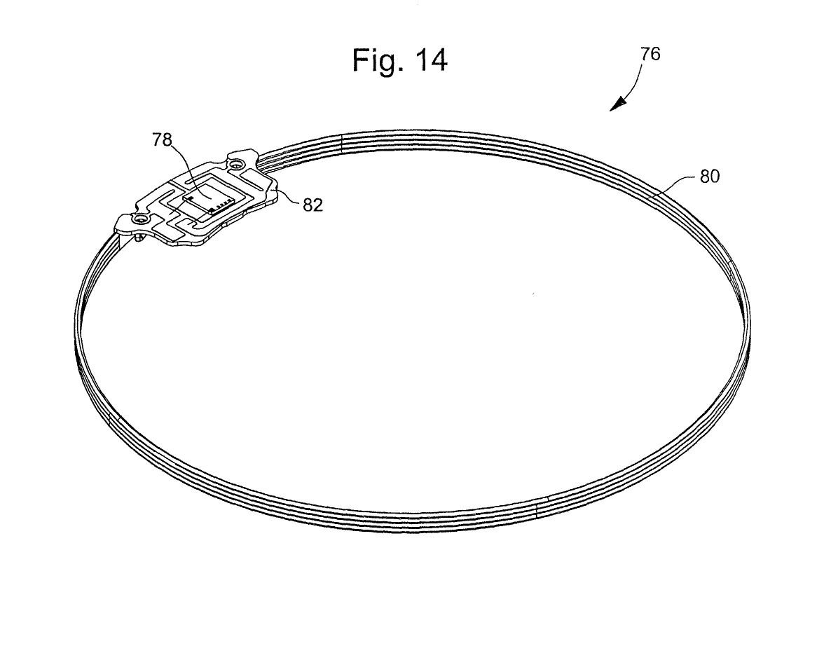

FIGS. 13 and 14 are perspective view of the transponder including an antenna and an integrated transmission and/or reception circuit; and

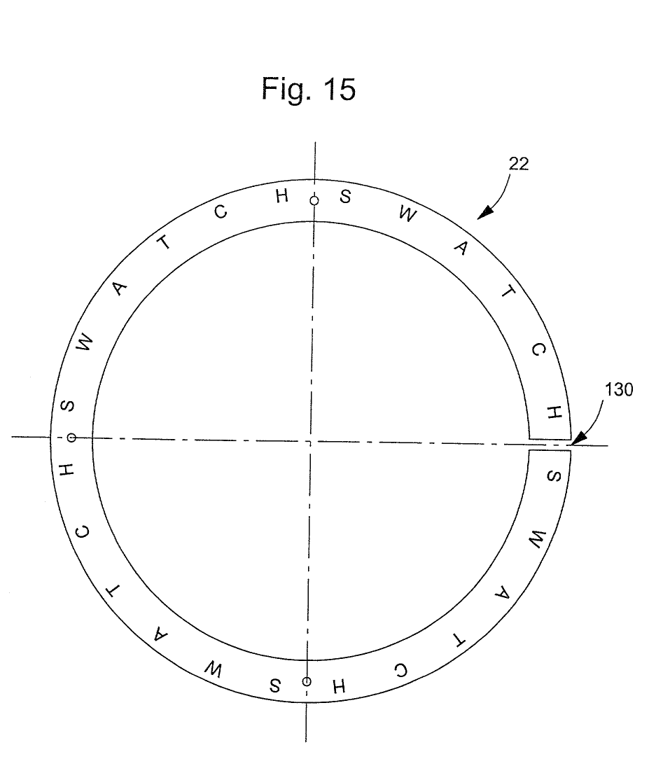

FIG. 15 is a top view of a slit metallic bezel.

The present invention proceeds from the general inventive idea which consists in arranging a slot in a metallic case so that the case has infinite electrical resistance and that no electric current induced by a variable electromagnetic field thus appears in said case. The case thus does not generate any back-electromotive force capable of disrupting a radio-broadcast interrogation signal emitted by a remote external interrogation device to a transponder housed in said case and including an antenna and an integrated transmission and/or reception circuit. Manufacturers are thus no longer limited in their choice to electrically non-conductive materials such as plastic or ceramic materials to make cases containing transponders, and may now also use metallic materials which are more resistant than plastic materials and less expensive than ceramics and which also allow changes in fashion to be followed.

The present invention will be described with reference to a timepiece such as a wristwatch. It goes without saying however that the invention is not limited to this single application and that it could advantageously be applied to any other portable object including a metallic case inside which transponder, for communicating with a remote external interrogation device, is housed.

FIG. 1 is a cross-section of a timepiece of the wristwatch type. Designated as a whole by the general reference numeral 1, this wristwatch includes a case 2 made of a metallic material. This case 2, which can be seen in more detail in FIGS. 2 and 3, is made in a single piece and includes an annular lateral part 4 in the form of the middle part and a back cover 6. It goes without saying that the case could be made in two parts, the back cover for example being screwed onto the middle part.

Middle part 4 includes in a conventional manner means for securing a wristband (not shown). These securing means include, arranged on either side of case 2, four horns 8 each pierced with a hole 10 for the passage of a connecting pin for securing the two strands of the wristband. These horns 8 may be, for example, of the type described in U.S. Pat. No. 4,624,581. Connected in pairs by roofs 12, they are made in a single piece with case 2 and are thus also made of metal.

Watch 1 further includes a dial 14 above which move analogue time display means formed by an hour hand 16, a minute hand 18 and a second hand 20. Of course, digital time display means formed, for example, by a liquid crystal display cell, may also be envisaged.

A bezel 22 which may be made of a metallic material or a plastic material, is fixed to case 2 by snap fitting as will be described in more detail hereinafter.

Advantageously, watch 1 according to the invention includes a container 24 which includes in particular a frame 26 made of a plastic material for example ABS. The electronic and mechanical horological components which allow time information to be generated, then transmitted to hands 16, 18 and 20, are directly mounted inside rigid frame 26 forming plastic container 24. The mounting of the horological components in container 24 is described in detail in Swiss Patent No. 643 704.

Container 24 is closed in a sealed manner by a crystal 28 which may be made for example of a plastic material such as PMMA. Crystal 28 is mounted in a fixed and sealed manner by its peripheral edge 30 onto the periphery of frame 26 for example by bonding or ultrasound welding. The technique of ultrasound welding a crystal made of plastic material onto a support part also made of plastic material is described in particular in U.S. Pat. Nos. 4,648,722 and 4,558,957.

Watch 1 further includes a control stem 32 which allows the aforementioned horological components to be activated. Stem 32 slides inside frame 26, an O-ring gasket being inserted between an inner cylindrical wall of a hole 36 of frame 26 and an annular groove made in said stem 32.

The aforementioned electronic components of watch 1 are powered by a battery 40 entirely housed inside container 24. For this purpose, a housing 42, commonly called the battery compartment, is arranged in container 24 and is closed in a sealed manner by a cover 44 having a bayonet type fixation device. This cover 44 is provided with a sealing gasket 46 which abuts resiliently against frame 26 and battery 40. This type of battery compartment closing device on a plastic case is described in U.S. Pat. No. 4,448,345.

It will be noted here however, that cover 44 is not fixed onto back cover 6 of case 2 of watch 1, as is usually the case, but onto rigid frame 26 made of plastic material forming container 24. Cover 44 of battery compartment 42 remains accessible however from the exterior as will be described hereinafter.

With regard to the foregoing, it is thus clear that frame 26, crystal 28, cover 44 and control stem 32 form an absolutely sealed independent container 24 provided with its battery 40. Thus, sealing tests and all the other tests of quality can be effected prior to mounting container 24 in metal case 2, so that the risk of mounting defective horological components or containers is case 2 is avoided. There is thus a high guarantee that each component and, in particular, container 24 mounted in metal case 2 is free of any defect. Operations of dismantling and re-assembling defective components are thus omitted, which contributes to a significant reduction in manufacturing costs.

As can be seen in FIG. 1, container 24 is suspended axially in case 2 via an O-ring sealing gasket 46 made of an elastically compressible material. This gasket 46 is arranged between an inner annular edge or rim 48 of case 2 and a corresponding projecting upper annular edge or rim 50 of container 24. O-ring gasket 46 is compressed axially against container 24 by the pressure exerted by bezel 22. Owing to the compressibility of gasket 46, container 24 is held resiliently in metallic case 2 and does not need to abut against back cover 6 of case 2. The transverse wedging of container 24 is assured by inner shoulders of case 2 which are not shown, provided above inner annular edge 48 of said case 2.

Since container 24 is only fixed in case 2 at the level of inner annular edge 48 of said case 2, a gap may advantageously be arranged between said case 2 and said container 24, all the way around the latter, which allows size tolerances to be increased and thus manufacturing costs to be reduced, for example by using moulding or stamping techniques. Container 24 remains fixed with no play even after its synthetic material, which is preferably ABS, has aged. Since the gap between case 2 and container 24 is sealed as regards the exterior by gasket 46, damp and dust cannot penetrate the gap, which prevent internal damage and the risk of bacteria developing which be inconvenient for the person wearing the watch. This sealing remains when cover 44 sealing battery compartment 42 is opened.

Sealed container 24 is held in place inside case 2 owing to metallic or plastic bezel 22 an inner annular shoulder 52 of which abuts axially against the upper surface of annular edge 50 of container 24 to compress O-ring gasket 46. Bezel 22 is held snap-fitted onto case 2 via shoulders of truncated shape 54 and 56 arranged respectively on said bezel 22 and in the lateral part 58 of case 2. Bezel 22 covers crystal 28 via a roof 60 intended to hide plastic container 24 from the view of the person wearing watch 1 according to the invention. This roof 60 generally does not touch crystal 28 but may nonetheless act as protection against said crystal 28 being accidentally pulled off.

As will be seen in more detail hereinafter, container 24 may be held in case 2 of watch 1 by means other than bezel 22.

Reference will now be made to FIGS. 4 and 5, which are perspective top and bottom views respectively of container 24.

Mono-shell container 24 is preferably made of an injection moulded plastic material. Seen from above, container 24 has a generally circular shape. It forms a bottom 62 and a lateral wall 64. It is closed by dial 14 and crystal 28 which is bonded or ultrasound welded in a groove 66 of lateral wall 64. The periphery of dial 14 abuts against a face 68 of lateral wall 64 and a plurality of positioning snugs 70 are provided to allow a date disc 72 to be centred.

The inner space limited by container 24 and dial 14 contains a motor module (not shown). This motor module is conventionally formed of a stator which takes the normal role of a magnetic circuit guiding the magnetic field created by one or more coils wound around a shaft which forms the mobile part of the motor. The rotor thus provides mechanical energy to a seconds wheel and pinion formed by a seconds wheel and a seconds pinion. The seconds wheel and pinion is mounted at the lower end of a seconds shaft which carries seconds hand 20. A cannon-pinion includes in a conventional manner a tube at the end of which the minutes hand is mounted and a minutes wheel and a minutes pinion. This assembly is of course secured in rotation. On the outer face of the cannon-pinion tube a cannon wheel is mounted, which includes, on the one hand, a tube on which the hour hand is mounted and, on the other hand, the hour wheel and hour pinion. In FIG. 4, posts 74 for positioning the motor are visible.

It will be recalled here that watch 1 according to the present invention is intended to communicate via radio-frequency waves with a remote external interrogation device.

For this purpose, watch 1 includes (see in particular FIGS. 13 and 14) a transponder 78 including a transmission and/or reception circuit 78 for a radiobroadcast signal and an antenna 80 connected to transmission and/or reception circuit 78. Antenna 80 is formed by a coil formed by a hundred or several hundred coils of copper wire depending on the resonant frequency at which one wishes said antenna 80 to operate. Typically, the resonant frequency of antenna 80 will be comprised between 125 kHz and 13 Mhz, the lowest frequencies being particularly well suited to services requiring neither great security in the transactions between watch 1 and the external control terminal, nor significant data exchange flux, while the highest frequencies will be reserved rather for services requiring significant transaction security (particularly bank transactions) and involving significant exchanges of data.

As can be seen in FIGS. 13 and 14, transmission and/or reception circuit 78 is formed by an integrated circuit encapsulated in a case and mounted on the surface of a printed circuit board 82. As is clear from FIG. 13, integrated circuit 78 is connected to the coils of antenna 80 via two contact pads 83 for example made of copper provided on printed circuit board 82.

Transponder 76 further includes means for powering transceiver circuit 78. These powering means may be formed by battery 40 of watch 1. However, according to a preferred variant of the invention, these powering means will take the form of a rectifier circuit for the signals picked up by antenna 80 of transponder 76. In the example shown in the Figures, this rectifier circuit includes two capacitors 84 which are placed on the surface of printed circuit board 82 and which are arranged next to transceiver circuit 78. Owing to this particularly advantageous arrangement, transponder 76 operates totally passively and autonomously, the energy necessary for it to operate being provided solely by the electromotive force generated in antenna 80 by the electromagnetic waves transmitted by the remote external interrogation device.

Antenna 80 of transponder 76 is housed in a groove 86 which runs along the inner perimeter of container 24 (see FIG. 4). A housing 88 is also arranged in lateral wall 64 of container 24 for accommodating printed circuit 82 on which transceiver circuit 78, which is connected to both free ends of antenna 82, is mounted.

Again in FIGS. 4 and 5, hole 36 arranged in lateral wall 64 of container 24 for allowing the passage of control stem 32 can be seen. Battery compartment 42 is provided in bottom 62 of said container 24. This battery compartment 42 takes the form of a blind hole of generally circular contour fitted to the profile of battery 40 which is housed in said battery compartment 42. In the bottom of battery compartment 42 there is arranged a through opening 90 which allows the contact leaf (not shown) of the electronic control module to be connected to the negative pole 92 of battery 40.

According to the present invention, watch case 2 is made of a metallic or other material which has the property of conducting electricity. In order for case 2 not to form an interfering antenna inside which a back-electromotive force would be induced which would disrupt communication between the remote external interrogation device and watch 1 according to the invention, a slot 94 (see FIGS. 2 and 3) is made in said case 2. This slot 94 is made in the lateral wall or middle part 4 of case 2, for example at 3 o'clock, i.e. where control stem 32 passes, and may extend into back cover 6 of case 2 as far as the centre thereof. Typically, the thickness of slot 94 will be of the order of two millimeters.

Owing to this feature, case 2 can be made of any type of material which conducts electricity without the sensitivity of the contactless remote communication system being altered. Indeed, since metallic case 2 is slit, it prevents the flow of any electric current because of its high electric resistance. Consequently, the electromagnetic waves transmitted by the remote external interrogation device will no longer be able to induce any back-electromotive force in metallic case 2 capable of disrupting communication between said external device and watch 1 according to the invention.

According to a complementary feature of the invention, metallic case 2 also has a recess 96 at its centre. As is clear from FIGS. 2 and 3, virtually all of back cover 6 of case 2 is hollowed out, only an inner annular edge 98 remaining, on which container 24 can be supported. Indeed, depending upon the magnetic permeability of the material used to manufacture case 2 and depending upon the surface area of said case 2 through which the electromagnetic field emitted by the remote external interrogation device passes, the flux picked up by case 2 will be more or less significant, so that the useful flux, i.e. the flux which will actually pass through antenna 80, is capable of varying, which may alter the quality and reliability of data exchanges between said external device and watch 1 according to the invention. In order to overcome this drawback, case 2 is thus hollowed out by removing as much material as possible. Thus, the surface area of case 2 through which the electromagnetic field passes is reduced, so that the flux which results from the product of the magnetic field intensity and the surface in question through which the field lines pass also decreases. For the same intensity of the electromagnetic field radiated by the remote external interrogation device, the useful flux which will pass through antenna 80 of transponder 76 is thus increased, so that communications between said external device and watch 1 are improved.

Case 2, slit and hollowed out at its centre, has however lower mechanical resistance, so that the traction stress exerted on the strands of the wristband may cause deformation of said case 2, which is capable of bending and opening. In order to overcome this drawback, two blind holes 100 are pierced on either side of slot 94, each of which accommodate mechanical holding means carried by container 24. Consequently, container 24 is mounted and held in place in case 2 and any traction effort exerted on said case 2 is entirely taken by container 24 which forms a mono-block unit which cannot be deformed and prevents case 2 from deforming.

According to a first variant shown in FIGS. 5 and 9, the mechanical holding means carried by container 24 comprise two stubs 102 which are made in a single piece with container 24 made of plastic material and which are housed in opposite holes 100 of metallic case 2.

According to a second variant shown in FIG. 10, the mechanical holding means carried by container 24 include two pins 104 driven into two blind holes 106 made in said container 24 and which are housed in opposite holes 100 of metallic case 2.

It goes without saying that blind holes 100 could be made in container 24 and that the mechanical holding means, studs 102 or pins 104, could be carried by metallic case 2.

It can also be seen in FIG. 5 that container 24 has a radial rib 108 which engages in slot 94 made in case 2 and whose cross-section 110 perfectly matches the profile of the outer contour of said metallic case 2. As a result of this feature, the unsightly aperture left by slot 94 is filled by rib 108 carried by container 24 and metallic case 2 has a smooth and continuous outer surface.

Again in FIG. 5, it can be seen that hole 36 for the passage of control stem 32 is made in radial rib 108 of container 24.

According to a third variant shown in FIGS. 6 to 8, arranged on either side of slot 94, case 2 has two housings 112 made in middle part 4 of said case 2 whose geometrical shapes are adapted to allow housings 112 each to accommodate a radial prismatic extension 114 of container 24. Moreover, it can be seen in FIG. 6 that case 2 has two stops 116 against which prismatic extensions 114 of container 24 abut in the event of traction on the wristband strands of watch 1 and which prevent said prismatic extensions 114 from slipping out of their housings 112. Finally, again in FIG. 6, it can be seen that slot 94 is arranged in case 2 at nine o'clock, i.e. opposite a hole 117 arranged in said case 2 for the passage of control stem 32.

In the preceding paragraphs, the manner in which container 24 was mounted and held in place axially in metallic case 2 by a bezel 22 snap fitted onto said case 2, was described. It goes without saying that other means of securing container 24 onto case 2 may also be envisaged.

Thus, within the simplest meaning of the present invention, container 24 is simply bonded onto back cover 6 of case 2. This solution has the advantage of being inexpensive to implement. However, the drawback of such a solution lies in the fact that the unit formed by sealed container 24 and case 2, after bonding, cannot be dismantled, so that the subsequent repair of watch 1 in the event of the failure of any of its components cannot be envisaged.

It may thus be wise to mount container 24 in case 2 in a removable manner. The present invention thus proposes making at least one radial hole 118 in middle part 4 of case 2, said hole 118 being extended by an opposite radial hole 120 made in lateral wall 64 of container 24. Mechanical holding means allowing container 24 to be held axially in case 2 are engaged in said holes 118, 120.

As is clear from FIGS. 2 to 5, holes 118, 120 are preferably four in number, holes 118 being provided in the housings of case 2 which accommodate the two strands of a wristband, i.e. arranged substantially at eleven o'clock, one o'clock, five o'clock and seven o'clock, whereas holes 120 are made facing holes 118 in anchoring studs 122 which are made in a single piece with container 24.

Holes 120 are blind holes which thus do not alter the sealing of container 24 and in which the aforementioned mechanical holding means are engaged allowing container 24 to be held axially in case 2.

According to a first variant shown in FIG. 11, these mechanical holding means are formed by pins 124 driven into anchoring holes 120 of container 24 and which are flush with the outer surface of said metallic case 2, these pins 124 having at their free end located on the side of said case 2 a hole 126 for accommodating a tool in order to remove them and dismantle watch 1.

According to a second variant shown in FIG. 12, the mechanical holding means allowing container 24 to be held axially in case 2 include screws 128 screwed radially into said case 2 and passing through case 2 so as to be engaged in said container 24.

Preferably, bezel 22 is made of a plastic material. It may however also be made of a metallic material. In such case, like metallic case 2, it will have to have a slot 130 (see FIG. 15) in order not to form an interfering antenna capable of altering communication between the remote external interrogation device and watch 1 according to the invention. Of course, slot 130 of metallic bezel 22 will have to be arranged plumb with slot 94 of case 2 so as not to close the electric circuit formed by said metallic case 2.

It goes without saying that the invention is not limited to the embodiments which have just been described, and that modifications and variants may be envisaged without departing from the scope of the present invention. In particular, slot 94 may be made in metallic case 2 at midday or at six o'clock, i.e. in the region in which horns 8 of said case are located. In such case, if the connecting pin which passes through holes 10 of horns 8 and which is intended to secure the wristband strands, is metallic, said connecting pin will have to be covered with a coating made of an insulating material such as a plastic material to prevent said connecting pin from closing the electrically conductive circuit formed by metallic case 2.

What is claimed is:

1. A portable object such as, in particular, a timepiece, intended to cooperate with a contactless remote interrogation system, this portable object including a metallic case and a transponder including a transmission and/or reception circuit for a radio-broadcast signal and an antenna connected to the transmission and/or reception circuit, a sealed container made of an electrically insulating material inside which the horological components are housed being mounted and held in place in the metallic case, wherein said metallic case has a slot.

2. The portable object according to claim 1, wherein the metallic case also has a recess at its centre.

3. The portable object according to claim 1, wherein two holes are machined on either side of the slot in the metallic case or in the container and each accommodate mechanical holding means carried by the container, or respectively the case.

4. The portable object according to claim 2, wherein two holes are machined on either side of the slot in the metallic case or in the container and each accommodate mechanical holding means carried by the container, or respectively the case.

5. The portable object according to claim 3, wherein the mechanical holding means include two pins driven into the container or the metallic case.

6. The portable object according to claim 4, wherein the mechanical holding means include two pins driven into the container or the metallic case.

7. The portable object according to claim 3, wherein the mechanical holding means include two studs which are formed in a single piece with the container made of insulating material or with the metallic case.

8. The portable object according to claim 4, wherein the mechanical holding means include two studs which are formed in a single piece with the container made of insulating material or with the metallic case.

9. The portable object according to claim 1, wherein two housings are provided on the metallic case on either side of the slot and each accommodate a radial prismatic extension of the edge of the container.

10. The portable object according to claim 2, wherein two housings are provided on the metallic case on either side of the slot and each accommodate a radial prismatic extension of the edge of the container.

11. The portable object according to claim 2, wherein the container has a rib which engages in the slot and whose cross-section perfectly matches the profile of the outer contour of the metallic case.

12. The portable object according to claim 1, wherein the container is bonded onto the back cover of the metallic case.

13. The portable object according to claim 1, wherein the container is held axially on the metallic case by mechanical holding means radially engaged in a hole made in the lateral wall of the metallic case and which extends into the container.

14. The portable object according to claim 13, wherein the holes are made in the metallic case substantially at midday and at six o'clock, in the zone where the strands of a wristband are attached to the metallic case.

15. The portable according to claim 13, wherein the hole pierced in the container is blind and accommodates a pin driven in until flush with the outer surface of the case, this pin having at its free end located on the side of said case a hole intended to accommodate a tool for removing said pin and dismantling the portable object.

16. The portable according to claim 14, wherein the hole pierced in the container is blind and accommodates a pin driven in until flush with the outer surface of the case, this pin having at its free end located on the side of said case a hole intended to accommodate a tool for removing said pin and dismantling the portable object.

17. A portable object according to claim 13, wherein the container is held axially on the metallic case by at least one screw radially screwed into said metallic case and passing through said case so as to be engaged in said container.

18. A portable object according to claim 14, wherein the container is held axially on the metallic case by at least one screw radially screwed into said metallic case and passing through said case so as to be engaged in said container.

19. The portable object according to claim 14, wherein the container is mounted and held in place in the metallic case by a bezel snap fitted onto said case.

20. The portable according to claim 19, wherein the bezel is made of plastic material.

21. The portable object according to claim 19, wherein the bezel is metallic and has a slot arranged plumb with the slot of the case.

22. The portable object according to claim 1, wherein the slot is made at three o'clock at the location of a control stem mounted in a sealed manner on the container.

23. The portable object according to claim 1, wherein the slot is made at nine o'clock, i.e. at a location diametrically opposite to a control stem mounted in a sealed manner on the container.

24. The portable object according to claim 1, wherein the slot is made at midday or at six o'clock and in that a connecting pin which allows the strands of a wristband to be secured to the metallic case is coated with a layer made of an electrically non-conductive material when it is itself metallic.
